(19) United States
(12) Patent Application Publication
(10) Pub. No.: US 2026/0003246 A1
(43) Pub. Date: Jan. 1, 2026

(54) NONLINEAR OPTICAL SYSTEM FOR GENERATING HIGH AVERAGE POWER TUNABLE LIGHT

(71) Applicant: Eagle Technology LLC, Melbourne, FL (US)

(72) Inventor: Brian Brickeen, Escondido, CA (US)

(21) Appl. No.: 18/754,415

(22) Filed: Jun. 26, 2024

(51) Int. Cl. G02F 1/39; G02F 1/35; G02F 1/355

(52) U.S. Cl. CPC G02F 1/392; G02F 1/3544; G02F 1/3551

(57) ABSTRACT

An image rotating optical parametric oscillator, comprising: optical elements that are (i) located and oriented to form a non-planar, image-rotating ring cavity and (ii) configured to rotate a resonating beam by a defined number of degrees for each round trip in the cavity; and non-linear optical crystal(s) configured to convert energy of a pump beam of light into an idler beam of light having a first color and a signal beam of light having a different second color; wherein the non-linear optical crystal(s) is (are) cut such that the idler beam of light propagates in a first direction that is different than a second direction in which the signal beam of light propagates through the at least one non-linear optical crystal; and wherein a power of the signal beam of light exiting the image rotating optical parametric oscillator is three to six magnitudes larger than a power of the signal or idler wave seed.

### BACKGROUND

### Description of the Related Art

Directed Energy (DE) systems have historically generated or produced a single color output in a fixed spectral line in the infrared spectrum when operating at higher pulse energies (>100 mJ) or higher repetition frequencies (>50 Hz) while maintaining high beam quality.

### SUMMARY

This document concerns systems comprising: an emitter configured to emit a pump beam of light; an optical system configured to a signal or idler wave seed from the pump beam of light; and an image rotating optical parametric oscillator configured to receive both the pump beam of light and the signal or idler wave seed as inputs, and generate an idler beam of light having a first color and a signal beam of light having a different second color. The image rotating optical parametric oscillator comprises at least one non-linear optical crystal with a crystal axis cut such that the idler beam propagates in a first direction that is different than a second direction in which the signal beam propagates through the at least one non-linear optical crystal. A power of the signal beam exiting the image rotating optical parametric oscillator is three to six orders of magnitude larger than a power of the signal or idler wave seed.

This document also concerns image rotating optical parametric oscillators comprising: a plurality of optical elements that are (i) located and oriented to form a non-planar, image-rotating ring cavity and (ii) configured to rotate a resonating beam by a defined number of degrees for each round trip in the cavity; and at least one non-linear optical crystal configured to convert energy of a pump beam of light into an idler beam of light having a first color and a signal beam of light having a different second color. The at least one non-linear optical crystal has a crystal axes cut such that the idler beam of light propagates in a first direction that is different than a second direction in which the signal beam of light propagates through the at least one non-linear optical crystal. A power of the signal beam of light exiting the image rotating optical parametric oscillator is three to six orders of magnitude larger than a power of the signal or idler wave seed.

This document further concerns methods for operating an optical system comprising: inputting a pump beam of light and a signal or idler wave seed into an image rotating optical parametric oscillator; causing the pump beam of light to travel along a path towards at least one non-linear optical crystal; and using the at least one non-linear optical crystal to shift a wavelength of the pump beam of light to generate an idler beam of light with a first color and a signal beam of light with a different second color of light. The non-linear optical crystal(s) has (have) crystal axes cut such that the idler beam propagates in a first direction that is different than a second direction in which the signal beam propagates through the at least one non-linear optical crystal. A power of the signal beam exiting the image rotating optical parametric oscillator is three to six orders of magnitude larger than a power of the signal or idler wave seed.

### BRIEF DESCRIPTION OF THE DRAWINGS

This disclosure is facilitated by reference to the following drawing figures, in which like numerals represent like items throughout the figures.

FIG. 1 provides an illustration of a system implementing the present solution.

FIG. 2 provides an illustration of an image rotating optical parametric oscillator.

FIG. 3 provides an illustration of that is useful for understanding beams of light generated by the crystal element shown in FIG. 2.

FIG. 4 provides a table listing crystal characteristics for generating different colors of light.

FIG. 5 provides an illustration of an architecture for a crystal element.

FIG. 6 provides an illustration of an architecture for an image rotating optical parametric oscillator.

FIG. 7 provides a flow diagram of an illustrative method for operating an optical system.

### DETAILED DESCRIPTION

As noted above, conventional laser or DE systems produce a single color output in a fixed spectral line in the infrared spectrum. Emerging technologies require flexibility for the output wavelength to extend into the visible light regions, with the capability to tune the specific wavelength line within pre-determined bands. While wavelength shifting of laser light using nonlinear processes is an established technique, the state-of-the-art either reduces beam quality or is limited by thermal distortions to either lower energy (<100 mJ) or lower repetition frequency (10's of Hz).

Optical parametric oscillator (OPO) systems and other nonlinear optical (NLO) systems exist commercially to convert light into the visible spectrum. For example, the OPO generally converts an input laser wave with a frequency w₁ into two output laser waves with lower frequencies w2, w3 (where w₁=w2+w3). The input laser wave is referred to as the pump wave, while the output laser waves are referred to as the signal beam and idler beam. However, the OPO systems and other NLO systems produce relatively lower energy (<100 mJ per pulse) and/or operate at a relatively lower repetition rate (˜10 Hz). Increasing both output energy and repetition rate is necessary to achieve DE objectives. Directly tunable laser systems such as Ti: Sapphire lasers do not cover the full visible spectrum without additional NLO processes, and are more suited for near-IR operation.

One deterrent to simply scaling the existing lower repetition rate OPO designs to higher energy and higher repetition rate is the thermal effects in the NLO crystal. The conversion of laser light to a different color in the NLO crystal is dependent on the angle of the laser beam electromagnetic wave with respect to the crystal axis. This angle is dependent on the material properties of the crystal, which in turn are dependent on the temperature and intensity. Running higher power through a crystal (either through increased energy and/or increased repetition frequency) can create thermal gradients and intensity-driven phase shifts in the largely insulating NLO crystal that limit and even degrade conversion efficiency. This effect can also degrade beam quality as the gradient effects can be stronger on the beam edges than the center.

The present solution concerns a novel solution in which directed energy laser light can be shifted into the visible spectrum at higher energy (>200 mJ) without significantly compromising efficiency or beam quality, for beams operating at higher repetition frequency (100's of Hz). The proposed solution involves minimizing the above-described effects in the NLO crystal by mitigating both the dephasing and the gradient profiles seen by the converted beam, thereby allowing higher energy extraction at an increased repetition frequency. There are several aspects to the OPO design that work together to create the localized environment in the interaction region of the beam in the NLO crystal that allow energy scaling at higher repetition rates.

The present solution implements the following features: operation at elevated crystal temperature to minimize thermal gradients; multiple NLO crystals to increase parametric interaction length and decrease volumetric insulation compared to larger bulk crystal; large spot sizes to move gradient edges further from beam center and minimize edge effect region as percentage of overall beam area; pump overfill and edge masking to minimize effective edge-effect region; image rotating oscillator architecture designed to improve output beam uniformity and symmetry and minimize impact of any preferential axis effects; an idler crystal seeded for simple injection; a contingency, signal seeded via a mater oscillator-power oscillator (MOPO) architecture that provides a reduced build-up time for parametric generation and an increase conversion efficiency at lower intensity pump; and an off-optimum crystal cut to leverage homogenizing effects for phase and amplitude corrections via walkoff between signal and idler beams. The novelty of this approach at least partially lies in the gradient mitigation, coupled with image rotation and phase homogenization, to extend operation of the nonlinear optical system to higher energy and repetition rate.

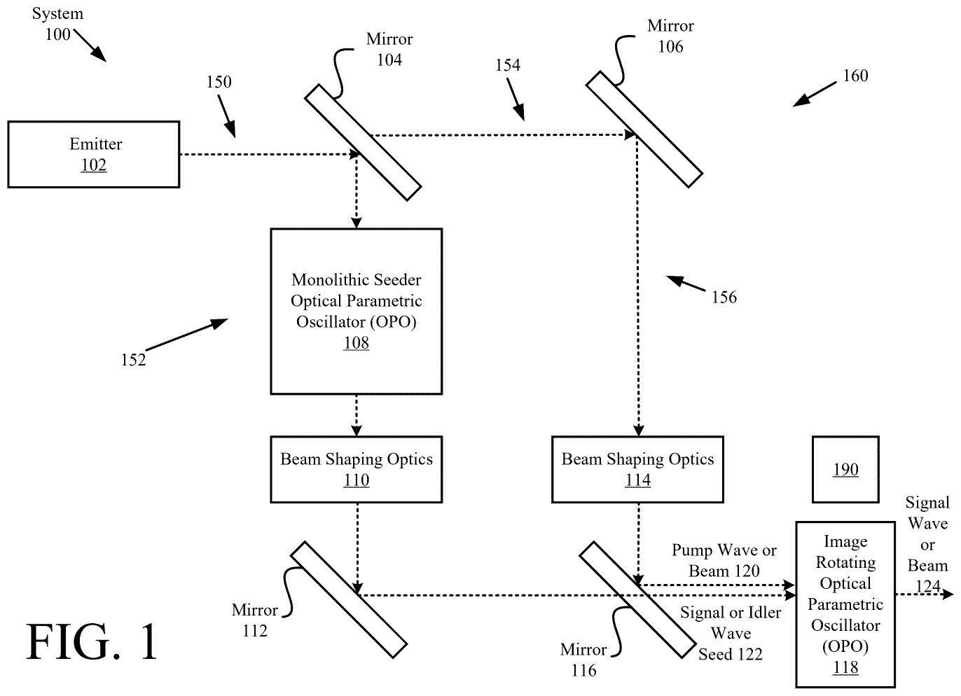

FIG. 1 provides an illustration of a system 100 implementing the present solution. System 100 can include, but is not limited to, a DE system. System 100 is configured to have both a relatively high pulse energy and a relatively high pulse repetition frequency, while power conversion efficiency and the laser beam quality are maintained. The relatively high pulse energy can include, for example, greater than 100 mJ per pulse. The relatively high pulse repetition frequency can include, for example, hundreds of pulses per second or more. The laser beam quality can be expressed in terms of how well the beam spreads out while it travels along a path and how focusable the beam is on a target.

System 100 comprises an emitter 102 and an optical system 160. Optical system 160 comprises mirrors 104, 106, 112, 116, a monolithic seeder OPO 108, and beam shaping optics 110, 114, and an image rotating OPO 118. Emitter 102 can include a laser configured to emit light. Any known or to be known laser can be used here. The light emitted from the emitter 102 is referred to as the pump wave or the pump beam of light.

The pump beam of light travels along a path 150 to tilted and reflective mirror 104. Mirror 104 is tilted relative to path 150. For example, mirror 104 is tilted at forty-five degrees relative to path 150. Mirror 104 can include, but is not limited to, glass, metal and/or a coated plastic. Mirror 104 may comprise a partially reflecting splitting mirror. The partially reflecting splitting mirror may be realized as a beam splitter. In this regard, mirror 104 causes a first portion of the emitted light beam to travel along path 152 and a second portion of the emitted light beam to travel along path 154.

Path 152 is provided to generate or produce a signal or idler wave seed 122. As the pump beam of light travels along path 152, the light beam passes through OPO 108 and beam shaping optics 110. The beam shaping optics 110 can include, but are not limited to, a collimating lens. The collimating lens can include a curved optical lens that make the rays of light parallel to each other. The resulting light is a partially collimated beam of light with a particular beam width. Collimating lens can include, but is not limited to, fused silica. The collimated beam of light travels further along path 152 towards tilted and reflective mirror 112. Mirror 112 is tilted relative to path 152. For example, mirror 112 is tilted at forty-five degrees relative to path 152. Mirror 112 can include, but is not limited to, glass, metal and/or a coated plastic. Mirror 112 redirects the light in a direction towards OPO 118. The redirected light is input into OPO 118 as the signal or idler wave seed 122.

Path 154 is provided to facilitate redirection of the pump beam of light 120 to the OPO 118. As the pump beam of light travels along path 154, the light is redirect by a tilted and reflective mirror 106. Mirror 106 is tilted relative to path 154. For example, mirror 106 is tilted at forty-five degrees relative to path 154. Mirror 106 can include, but is not limited to, glass, metal and/or a coated plastic. The redirected light travels along path 156 towards beam shaping optics 114. The beam shaping optics 114 can include, but are not limited to, a collimating lens. The collimating lens can include a curved optical lens that make the rays of light parallel to each other. The resulting light is a partially collimated beam of light with a particular beam width. Collimating lens can include, but is not limited to, fused silica. The collimated beam of light travels further along path 156 towards tilted and reflective mirror 116. Mirror 116 is tilted relative to path 156. For example, mirror 116 is tilted at forty-five degrees relative to path 156. Mirror 116 can include, but is not limited to, glass, metal and/or a coated plastic. Mirror 116 redirects the light in a direction towards OPO 118. The redirected light is input into OPO 118.

OPO 118 comprises an image rotating OPO. The image rotating OPO has demonstrated improved beam quality compared to linear or non-linear rotating ring oscillators. The image rotating OPO divergence is relatively smaller than that of the linear or non-linear rotating ring oscillators, and the symmetry of the output beam is improved as compared to that of linear or non-linear rotating ring oscillators. The longer optical path is compatible with multi-crystal configurations, and the oscillator is relatively insensitive to small angular errors such that a monolithic device is possible. The term “monolithic” as used in this case refers to a fixed structure without adjustments. Increased mechanical complexity, and non-standard mirror coatings due to the off-normal or non −45° angle of incidence on one or more mirrors in OPO 118. The output of OPO 118 is signal beam 124.

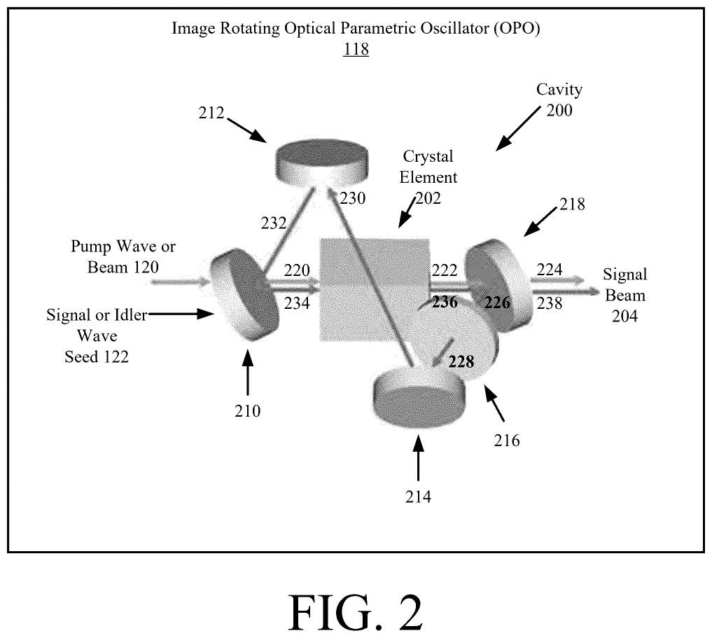

A more detailed illustration of OPO 118 is provided in FIG. 2. As shown in FIG. 2, OPO 118 comprises a cavity 200 in which optical elements 210-218 and crystal element 202 are disposed. The optical elements 210-218 are located and oriented to form a non-planar, image-rotating ring cavity 200. The optical elements 210-218 can include, but are not limited to, reflective mirrors or reflective surfaces. The optical elements 210-218 are configured to rotate the resonating beam by a defined number of degrees for each round trip in the cavity 200. The defined number of degrees can include, but is not limited to, ninety degrees. The crystal element 202 is configured to convert energy of the pump wave 120 into the signal beam 204 and an idler beam (not shown in FIG. 2) with both signal and idler beams propagating in different directions. The idler beam propagates in the same direction as the pump wave 120. The crystal element 202 comprises one or more non-linear optical crystals that are cut to cause walk off of the signal beam relative to the idler beam. The non-linear optical crystals can include, but are not limited to, beta barium borate (BBO) crystals and/or lithium triborate (LBO) crystals. This idler beam walk off will be discussed in more detail below.

As shown in FIG. 2, the pump wave 120 travels from an input of OPO 118 and into the cavity 200 for conversion to the desired signal wavelength. In the cavity 200, pump wave 120 travels through optical element 210, crystal element 202 and optical element 218 as shown by arrows 220, 222, 224. A portion of the signal light is reflected by optical element 218 in a direction towards optical element 216, as shown by arrow 226. The reflective light travels further to optical element 214 which redirects the light towards optical element 212, as shown by arrows 228 and 230. Optical element 212 redirects the light to optical element 210 as shown by arrow 232. This redirected light then travels through crystal element 202 and optical element 218 to the output of OPO 118, as shown by arrows 234, 236 and 238.

The color of the light is shifted inside the non-linear optical crystal(s) of the crystal element 202, whereby a signal beam 204 is generated or produced with a desired wavelength. The power of signal beam 204 at the desired wavelength is three to six orders of magnitude larger than the power of the signal or idler seed 122. The power of the signal or idler seed 122 may be, for example, on the order of ten microjoules. The present solution is not limited in this regard. It should be noted that the power of the pump wave 120 is greater than the power of the signal or idler seed 122 and greater than the power of the signal beam 204.

OPO 118 can be tuned to output a particular color (wavelength) of light by (i) changing the wavelength of the pump wave 120, (ii) changing the temperature of the non-linear crystal(s), and/or (iii) changing the angular orientation of the non-linear optical crystal(s) of the crystal element 202 relative to the incident propagation direction of the pump beam. With regard to feature (ii), a cooling and/or heating element 190 may be provided to facilitate the cooling and/or heating of one or more crystals of OPO 118. Any known or to be known cooling and/or heating element can be used here. With regard to feature (iii), OPO 118 may be configured to have a plurality of interchangeable crystals with different cuts. Additionally or alternatively, OPO 118 can be interchanged or otherwise replaced with another OPO configured to output a different color of light than the color of light that OPO 118 is configured to output. In this case, the non-linear optical crystal(s) 202 of OPO 118 can have a different cut than the non-linear optical crystal(s) of another OPO that can replace OPO 118.

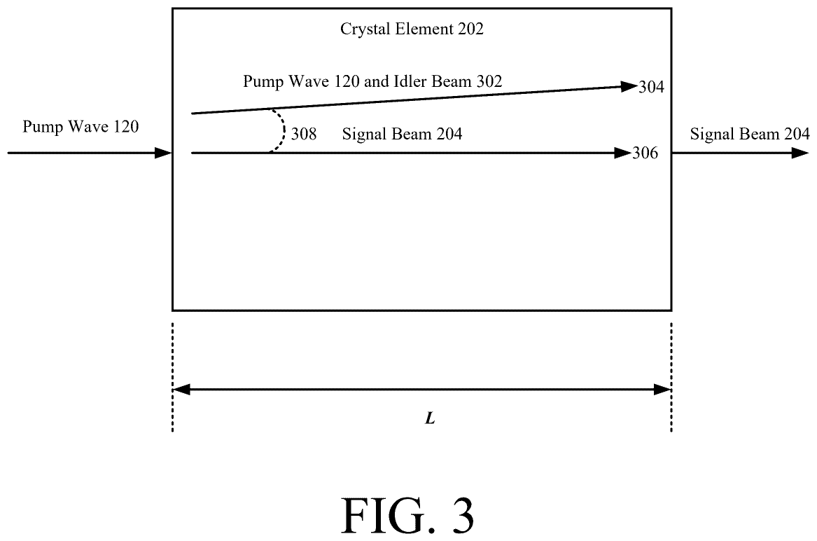

An illustration is provided in FIG. 3 that is useful for understanding the attributes of the crystal element 202. Crystal element 202 comprises one or more non-linear optical crystals selected to meet the following criteria: (i) possess adequate transmission at the signal, idler and pump wavelengths; and (ii) an ability to phase match light waves. Each non-linear optical crystal is cut along its axis in a manner such that an idler beam 302 and the signal beam 204 do not propagate co-linearly. In this regard, the idler beam 302 walks-off or propagates in a direction 304 that is colinear with the pump beam but angled relative to the direction 306 that the output signal 204 propagates. The angle 308 can have a value greater than zero or one degrees and/or less than or equal to ninety degrees. This type of crystal cut is novel in that conventional systems utilize crystals cut to maximize the conversion efficiency of the pump light to the signal light, typically via collinearity of the signal with the pump beam. The conventional crystal cut results in a reduced beam quality. Crystal(s) of the crystal element 202 has (have) an overall length L selected to provide a particular power of signal beam 204 at the desired wavelength. For example, length L is selected to be one to two centimeters. The present solution is not limited to the particulars of this example.

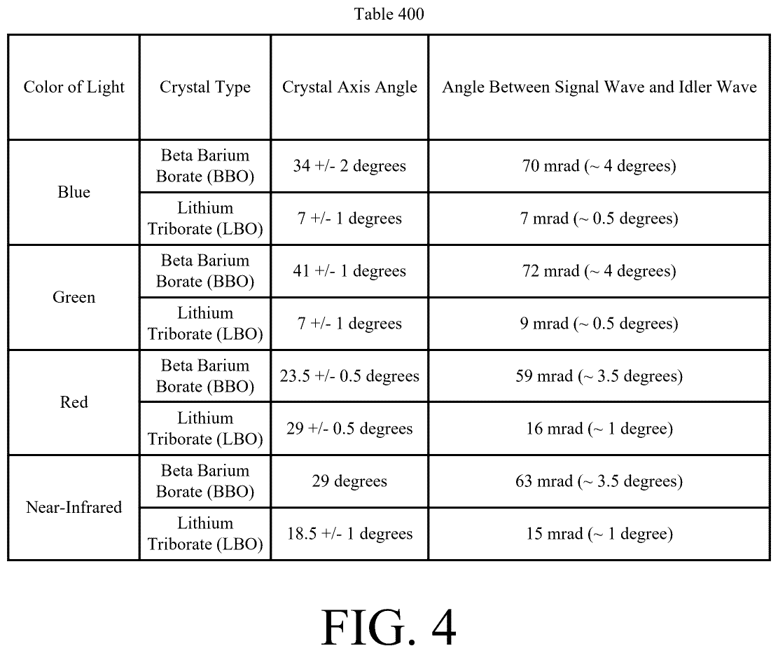

A table 400 is provided in FIG. 4 that is useful for understanding how the non-linear optical crystal(s) is (are) cut to generate or produce certain colors of light at the OPO output. The technical approach described herein is applicable to a broader selection of crystals and wavelengths than what are shown in table 400 of FIG. 4. Table 400 lists the particular of crystals that can be used, for example, in DE systems. In general, any crystal and output wavelength bands can be used with the present solution. The crystals described in table 400 can be used to generate or produce different colors of light through the visible light spectrum and the near-infrared spectrum. The type of crystals in Table 400 include BBO crystals and LBO crystals. The angle between the signal and idler beams generated in the crystal varies depending on which crystal is being used and which wavelength band is being generated. The cut of the crystal axes varies similarly.

As shown in Table 400, BBO crystal(s) and/or LBO crystal(s) can be used to generate blue light, green light, red light and near-infrared light. For generating blue light, the BBO crystal axis angle may be 34+/−2 degrees, and the angle between signal and idler waves may be 70 mrad (˜4 degrees). The LBO crystal axis angle is 7+/−1 degrees, and the angle between signal and idler waves is 7 mrad (˜0.5 degrees). For generating green light, the BBO crystal axis angle is 41+/−1 degrees and the angle between signal and idler waves is 72 mrad (˜4 degrees). The LBO crystal axis angle is 7+/−1 degrees, and the angle between signal and idler waves is 9 mrad (˜0.5 degrees). For generating red light, the BBO crystal axis angle is 23.5+/−0.5 degrees, and the angle between signal and idler waves is 59 mrad (˜3.5 degrees). The LBO crystal axis angle is 29+/−0.5 degrees, and the angle between signal and idler waves is 16 mrad (˜1 degree). For generating near-infrared light, the BBO crystal axis angle is 29 degrees, and the angle between signal and idler waves is 63 mrad (˜3.5 degrees). The LBO crystal axis angle is 18.5+/−1 degrees, and the angle between signal and idler waves is 15 mrad (˜1 degree). The present solution is not limited to the particulars of Table 400.

In some scenarios, BBO crystal(s) is (are) used with a crystal axis angle between 20 degrees and 45 degrees. The angle between signal and idler waves is between 3 degrees and 5 degrees. In those or other scenarios, LBO crystal(s) is (are) used with a crystal axis between 5 degrees and 30 degrees. The angle between signal and idler waves is between 0.1 degrees and 3 degrees. The present solution is not limited the particulars of these scenarios.

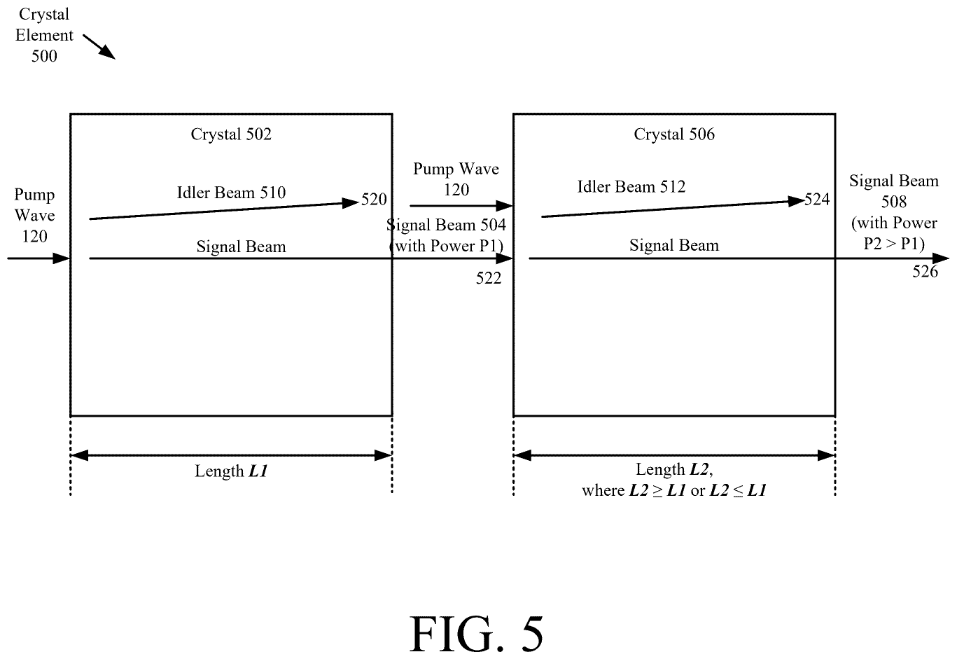

FIG. 5 provides an illustration showing an illustrative multi-crystal arrangement for a crystal element 500. Crystal element 202 of FIG. 2 may be the same as or similar to crystal element 500. Crystal element 500 can have two non-linear optical crystals 502, 506 arranged in series in a path along which light travels. The crystals 502 and 506 can be serially arranged, for example, between mirrors 210 and 218 of OPO 118. Crystal 502 can have a length L1 that is the same as or different than the length L2 of crystal 506. In the latter case, length L1 may be equal to L2, less than L2, or greater than L2. Each of the lengths L1 and L2 may be, for example, one to two centimeters.

Each of the crystals 502, 506 is cut in a manner to cause an idler beam 510, 512 and the signal 504, 508 to propagate in different directions 520, 522 or 524, 526. Directions 420 and 524 may be the same as each other or different from each other provided that the idler beam walk off in crystal 502 is not entirely canceled by an opposite walk off in crystal 506. Directions 522 and 526 are the same. This multi-crystal arrangement generates or produces a signal 504 with a power P1 that is output from crystal 502 and a signal 508 with a power P2 that is output from crystal 506. Power P2 is greater than the power P1.

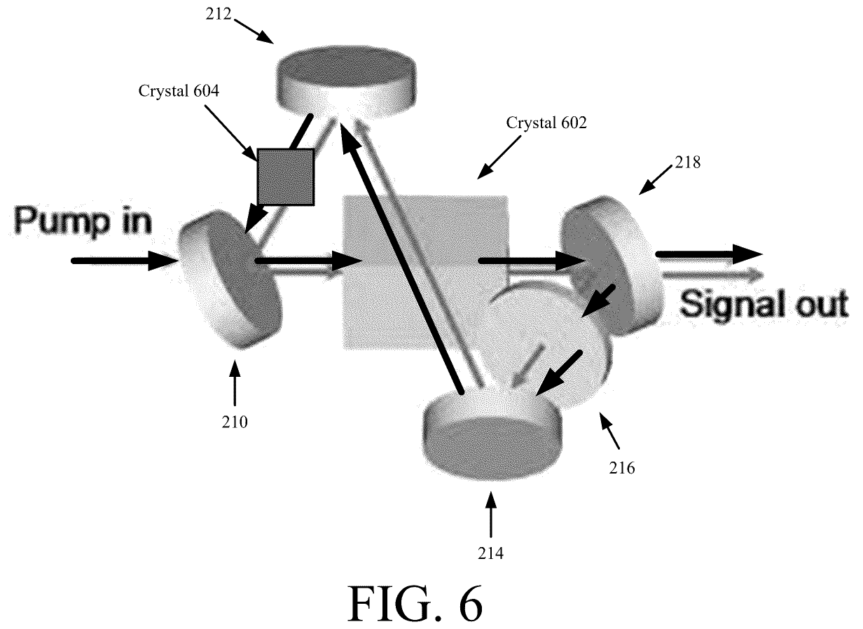

The present solution is not limited to the multi-crystal arrangement shown in FIG. 5. Another illustrative multi-crystal arrangement is shown in FIG. 6. In this case, a first non-linear optical crystal 602 is disposed in the light path between a first set of mirrors 210 and 218, while a second non-linear optical crystal 604 is disposed in the light path between a different set of mirrors. For example, the second crystal 604 is disposed between mirrors 212 and 210. The present solution is not limited to the particulars of this example. The second crystal 604 may alternatively be disposed between mirrors 214 and 212, mirrors 218 and 216, or mirrors 216 and 214. Crystals 602 and 604 may be the same as or different than crystals 502, 506.

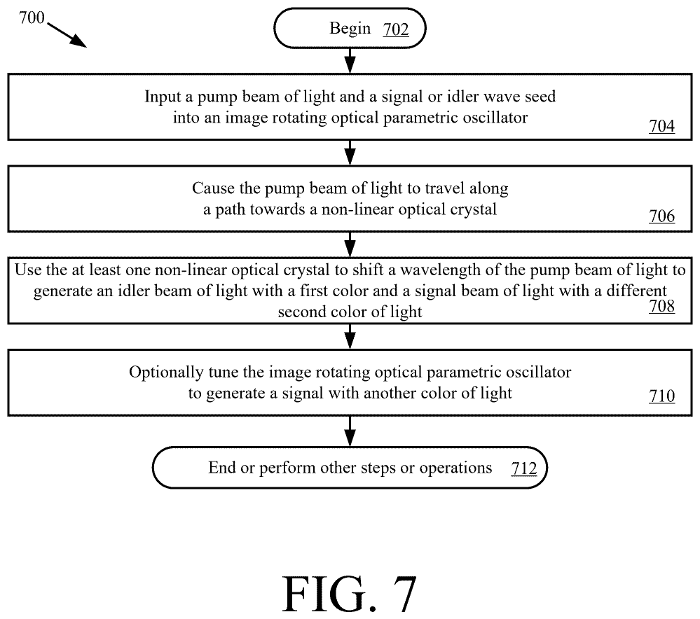

FIG. 7 provides a flow diagram of a method 700 for operating an optical system (e.g., optical system 100 of FIG. 1 and/or OPO 118 of FIG. 1). Method 700 begins with 702 and continues to 704 where a pump beam of light (e.g. pump beam 120 of FIG. 1) and a signal or idler wave seed (e.g., seed 122 of FIG. 1) are input into an image rotating optical parametric oscillator (e.g., image rotating OPO 118 of FIG. 1). Next in 706, the pump beam of light is caused to travel along a path towards a non-linear optical crystal (e.g., crystal element 202 of FIGS. 2-3, crystal element 500 of FIG. 5, crystal 502 of FIG. 5 and/or crystal 506 of FIG. 5). The non-linear optical crystal is used in 708 to shift a wavelength of the pump beam of light to generate an idler beam of light (e.g., idler beam 302 of FIG. 3, 510 of FIG. 5, or 512 of FIG. 5) with a first color and a signal beam of light (e.g., signal beam 124 of FIG. 1, signal beam 204 of FIGS. 2-3, 504 of FIG. 5 or 508 of FIG. 5) with a different second color of light. The non-linear optical crystal is cut such that the idler beam propagates in a first direction (e.g., direction 304 of FIG. 3, 520 of FIG. 5 or 524 of FIG. 5) that is different than a second direction (e.g., direction 306 of FIG. 3, 522 of FIG. 5, or 526 of FIG. 5) in which the signal beam propagates through the at least one non-linear optical crystal. A power of the signal beam exiting the image rotating optical parametric oscillator is three to six orders of magnitude larger than a power of the signal or idler wave seed.

Optional block 710 involves tuning the image rotating optical parametric oscillator to generate a signal with another particular color of light. This tuning may be achieved by (i) changing a wavelength of that pump beam of light, (ii) changing a temperature of the non-linear optical crystal(s), and (iii) changing the angular orientation of the non-linear optical crystal(s) relative to the incident propagation direction of the pump beam. Upon completing the steps of block 708 or 710, method 700 continues to block 712 where its ends or other steps or operations are performed. The other steps or operations can include, but are not limited to, returning to block 702.

In view of the forgoing discussion, the present solution concerns systems (e.g., system 100 of FIG. 1) comprising: an emitter (e.g., emitter 102 of FIG. 1) configured to emit a pump beam of light (e.g., pump beam 120 of FIG. 1); an optical system (e.g., components 108, 110, 112 and/or 116 of FIG. 1) configured to generate a signal or idler wave seed (e.g., seed 122 of FIG. 1) from the pump beam of light; and an image rotating optical parametric oscillator (e.g., OPO 118 of FIG. 1) configured to receive both the pump beam of light and the signal or idler wave seed as inputs, and generate or produce an idler beam of light (e.g., idler beam 302 of FIG. 3, 510 of FIG. 5 or 512 of FIG. 5) having a first color and a signal beam of light (e.g., signal beam 124 of FIG. 1, signal beam 204 of FIGS. 2-3, 504 of FIG. 5, or 508 of FIG. 5) having a different second color. The image rotating optical parametric oscillator comprises at least one non-linear optical crystal (e.g., crystal element 202 of FIGS. 2-3, crystal 502 of FIG. 5, crystal 506 of FIG. 5, 602 of FIG. 6, or 604 of FIG. 6) is cut such that the idler beam propagates in a first direction (e.g., direction 304 of FIG. 3, 520 of FIG. 5, or 524 of FIG. 5) that is different than a second direction (e.g., direction 306 of FIG. 3, 522 of FIG. 5, or 526 of FIG. 5) in which the signal beam propagates through the non-linear optical crystal(s). A power of the signal beam exiting the image rotating optical parametric oscillator may be three to six magnitudes larger than a power of the signal or idler wave seed.

The non-linear optical crystal may comprise: a BBO crystal with a crystal axis angle between 20 degrees and 45 degrees, or a LBO crystal(s) with a crystal axis between 5 degrees and 30 degrees. In the BBO case, the angle between the first and second directions may be between 3 degrees and 5 degrees. In the LBO case, the angle between the first and second directions may be between 0.1 degrees and 3 degrees.

The image rotating optical parametric oscillator may comprise a plurality of non-linear optical crystals having a same cut. The non-linear optical crystals may have a same length or different lengths. A walk off of the idler beam in a first non-linear optical crystal of the image rotating optical parametric oscillator is unchanged, or not fully compensated, or increased by a walk off in a second non-linear optical crystal of the image rotating optical parametric oscillator.

In some scenarios, the non-linear optical crystals may be serially arranged between first and second optical elements (e.g., optical elements 210, 218 of FIG. 2) of the image rotating optical parametric oscillator. An intermediary signal beam (e.g., signal beam 504 of FIG. 5) is generated when the pump beam of light travels through a first crystal (e.g., crystal 502 of FIG. 5) and the signal beam is generated when both the pump beam of light and the intermediary signal beam travel through a second crystal (e.g., crystal 506 of FIG. 5). A power of the signal beam is greater than a power of the intermediary signal beam.

In other scenarios, a first one of the non-linear optical crystals (e.g., crystal 602 of FIG. 6) is disposed between optical elements of a first set (e.g., optical elements 210, 218 of FIG. 6) and a second one of the non-linear optical crystals (e.g., crystal 604 of FIG. 6) is disposed between optical elements of a different set (e.g., optical elements 210, 212 of FIG. 6).

The present solution also concerns image rotating optical parametric oscillators, comprising: a plurality of optical elements (e.g., optical elements 210, 212, 214, 216, 218 of FIG. 2) that are (i) located and oriented to form a non-planar, image-rotating ring cavity and (ii) configured to rotate a resonating beam by a defined number of degrees for each round trip in the cavity; and at least one non-linear optical crystal (e.g., crystal element 202 of FIG. 2, crystal 502 of FIG. 5, crystal 506 of FIG. 5, crystal 602 of FIG. 6, or crystal 604 of FIG. 6) configured to convert energy of a pump beam of light (e.g. pump beam 120 of FIG. 1) into an idler beam of light (e.g., idler beam 302 of FIG. 3, 510 of FIG. 5, or 512 of FIG. 5) having a first color and a signal beam of light (e.g., signal beam 204 of FIG. 2, 504 of FIG. 5, or 508 of FIG. 5) having a different second color. The non-linear optical crystal(s) is (are) cut such that the idler beam of light propagates in a first direction (e.g., direction 304 of FIG. 3, 520 of FIG. 5, or 524 of FIG. 5) that is different than a second direction (e.g., direction 306 of FIG. 3, 522 of FIG. 5, or 526 of FIG. 5) in which the signal beam of light propagates through the non-linear optical crystal(s). A power of the signal beam of light exiting the image rotating optical parametric oscillator may be three to six orders of magnitude larger than a power of the signal or idler wave seed.

The non-linear optical crystal can include, but is not limited to, a BBO crystal with a crystal axis angle between 20 degrees and 45 degrees, or an LBO with a crystal axis between 5 degrees and 30 degree. In the BBO case, an angle between the first and second directions may be between 3 degrees and 5 degrees. In the LBO case, the angle between the first and second directions may be between 0.1 degrees and 3 degrees.

The image rotating optical parametric oscillator may comprise a plurality of non-linear optical crystals having a same cut. A walk off of the idler beam in a first non-linear optical crystal of the image rotating optical parametric oscillator is unchanged, or not fully compensated, or increased by a walk off in a second non-linear optical crystal of the image rotating optical parametric oscillator.

In some scenarios, the non-linear optical crystals are serially arranged between first and second optical elements of the image rotating optical parametric oscillator. A first one of the plurality of non-linear optical crystals may be disposed between optical elements of a first set and a second one of the plurality of non-linear optical crystals is disposed between optical elements of a different second set.

The present solution also concerns methods for operating an optical system. The methods comprise: inputting a pump beam of light and a signal or idler wave seed into an image rotating optical parametric oscillator; causing the pump beam of light to travel along a path towards at least one non-linear optical crystal; using the at least one non-linear optical crystal to shift a wavelength of the pump beam of light to generate an idler beam of light with a first color and a signal beam of light with a different second color of light; and/or tuning the image rotating optical parametric oscillator to generate or produce a signal with another particular color of light by (i) changing a wavelength of that pump beam of light, (ii) changing a temperature of the at least one non-linear optical crystal, and (iii) using at least one other non-linear optical crystal that is cut differently than the at least one non-linear optical crystal. The non-linear optical crystal is cut such that the idler beam propagates in a first direction that is different than a second direction in which the signal beam propagates through the at least one non-linear optical crystal. A power of the signal beam exiting the image rotating optical parametric oscillator is three to six orders of magnitude larger than a power of the signal or idler wave seed. A walk off of the idler beam in a first non-linear optical crystal of the image rotating optical parametric oscillator is unchanged, or not fully compensated, or increased by a walk off in a second non-linear optical crystal of the image rotating optical parametric oscillator.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with a particular implementation is included in at least one embodiment. Thus, discussions of the features and advantages, and similar language, throughout the specification may, but do not necessarily, refer to the same embodiment.

Furthermore, the described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

We claim:

1. A system, comprising:
an emitter configured to emit a pump beam of light;
an optical system configured to a signal or idler wave seed from the pump beam of light; and
an image rotating optical parametric oscillator configured to receive both the pump beam of light and the signal or idler wave seed as inputs, and generate an idler beam of light having a first color and a signal beam of light having a different second color;
wherein the image rotating optical parametric oscillator comprises at least one non-linear optical crystal is cut such that the idler beam propagates in a first direction that is different than a second direction in which the signal beam propagates through the at least one non-linear optical crystal; and
wherein a power of the signal beam exiting the image rotating optical parametric oscillator is three to six magnitudes larger than a power of the signal or idler wave seed.

2. The system according to claim 1, wherein the image rotating optical parametric oscillator comprises a plurality of non-linear optical crystals having a same cut.

3. The system according to claim 2, wherein the plurality of non-linear optical crystals have different lengths.

4. The system according to claim 2, wherein the plurality of non-linear optical crystals are serially arranged between first and second optical elements of the image rotating optical parametric oscillator.

5. The system according to claim 4, wherein an intermediary signal beam is generated when the pump beam of light travels through a first crystal of the plurality of non-linear optical crystals and the signal beam is generated when both the pump beam of light and the intermediary signal beam travel through a second crystal of the plurality of non-linear optical crystals, a power of the signal beam being greater than a power of the intermediary signal beam.

6. The system according to claim 2, wherein a first one of the plurality of non-linear optical crystals is disposed between cavity mirrors of a first mirror set and a second one of the plurality of non-linear optical crystals is disposed between cavity mirrors of a different second mirror set.

7. The system according to claim 2, wherein a walk off of the idler beam in a first non-linear optical crystal of the image rotating optical parametric oscillator is unchanged, not fully compensated, or increased by a walk off in a second non-linear optical crystal of the image rotating optical parametric oscillator.

8. The system according to claim 1, wherein the at least one non-linear optical crystal comprises a crystal with a crystal axis angle between 20 degrees and 45 degrees, and an angle between the first and second directions is between 3 degrees and 5 degrees.

9. The system according to claim 1, wherein the at least one non-linear optical crystal comprises a crystal with a crystal axis between 5 degrees and 30 degrees, and an angle between the first and second directions is between 0.1 degrees and 3 degrees.

10. An image rotating optical parametric oscillator, comprising:
a plurality of optical elements that are (i) located and oriented to form a non-planar, image-rotating ring cavity and (ii) configured to rotate a resonating beam by a defined number of degrees for each round trip in the cavity; and
at least one non-linear optical crystal configured to convert energy of a pump beam of light into an idler beam of light having a first color and a signal beam of light having a different second color;
wherein the at least one non-linear optical crystal is cut such that the idler beam of light propagates in a first direction that is different than a second direction in which the signal beam of light propagates through the at least one non-linear optical crystal; and
wherein a power of the signal beam of light exiting the image rotating optical parametric oscillator is three to six magnitudes larger than a power of the signal or idler wave seed.

11. The image rotating optical parametric oscillator according to claim 10, wherein a walk off of the idler beam in a first non-linear optical crystal of the image rotating optical parametric oscillator is unchanged, not fully compensated, or increased by a walk off in a second non-linear optical crystal of the image rotating optical parametric oscillator.

12. The image rotating optical parametric oscillator according to claim 10, wherein the image rotating optical parametric oscillator comprises a plurality of non-linear optical crystals having a same cut.

13. The system according to claim 13, wherein the plurality of non-linear optical crystals have different lengths.

14. The image rotating optical parametric oscillator according to claim 13, wherein the plurality of non-linear optical crystals are serially arranged between first and second optical elements of the image rotating optical parametric oscillator.

15. The image rotating optical parametric oscillator according to claim 13, wherein a first one of the plurality of non-linear optical crystals is disposed between cavity mirrors of a first mirror set and a second one of the plurality of non-linear optical crystals is disposed between cavity mirrors of a different second mirror set.

16. The image rotating optical parametric oscillator according to claim 10, wherein the at least one non-linear optical crystal comprises a crystal with a crystal axis angle between 20 degrees and 45 degrees, and an angle between the first and second directions is between 3 degrees and 5 degrees.

17. The image rotating optical parametric oscillator according to claim 10, wherein the at least one non-linear optical crystal comprises a crystal with a crystal axis between 5 degrees and 30 degrees, and an angle between the first and second directions is between 0.1 degrees and 3 degrees.

18. A method for operating an optical system, comprising:
inputting a pump beam of light and a signal or idler wave seed into an image rotating optical parametric oscillator;
causing the pump beam of light to travel along a path towards at least one non-linear optical crystal; and
using the at least one non-linear optical crystal to shift a wavelength of the pump beam of light to generate an idler beam of light with a first color and a signal beam of light with a different second color of light;
wherein the at least one non-linear optical crystal is cut such that the idler beam propagates in a first direction that is different than a second direction in which the signal beam propagates through the at least one non-linear optical crystal; and
wherein a power of the signal beam exiting the image rotating optical parametric oscillator is three to six magnitudes larger than a power of the signal or idler wave seed.

19. The method according to claim 18, further comprising tuning the image rotating optical parametric oscillator to generate a signal with another particular color of light by (i) changing a wavelength of that pump beam of light, (ii) changing a temperature of the at least one non-linear optical crystal, and (iii) changing an angular orientation of the at least one non-linear optical crystal relative to an incident propagation direction of the pump beam.

20. The method according to claim 18, wherein a walk off of the idler beam in a first non-linear optical crystal of the image rotating optical parametric oscillator is unchanged, not fully compensated, or increased by a walk off in a second non-linear optical crystal of the image rotating optical parametric oscillator.
